(19) United States
(12) Patent Application Publication
(10) Pub. No.: US 2010/0221374 A1
(43) Pub. Date: Sep. 2, 2010

(54) Modular tablet press and coater

(76) Inventor: Jean Y. Le Floc'h, Palatine, IL (US)

Correspondence Address: PAULEY PETERSEN & ERICKSON, 2800 WEST HIGGINS ROAD, SUITE 365, HOFFMAN ESTATES, IL, 60169, US

(21) Appl. No.: 12/658,865

(22) Filed: Feb. 16, 2010

Related U.S. Application Data
(60) Provisional application No. 61/152,847, filed on Feb. 16, 2009.

(51) Int. Cl. B30B 11/34; B05C 13/00

(52) U.S. Cl. 425/94; 118/56

(57) ABSTRACT

A processing unit preferably includes a tablet press module for producing and compressing tablets and a coating module for coating the tablets with a solution or a suspension. The processing unit includes a housing and a motor and one or more coating modules and tablet press modules that are removably connected with respect to the housing and the motor. The processing unit may include a single platform accommodating a single interchangeable module or dual interchangeable modules so that both compression and coating may be accomplished in a single platform.

### CROSS REFERENCE TO RELATED APPLICATION

This Application claims the benefit of U.S. Provisional Patent Application Ser. No. 61/152,847, filed 16 Feb. 2009, which is incorporated herein by reference.

### BACKGROUND OF THE INVENTION

1. Field of the Invention

This invention relates to a modular processing apparatus for producing a tablet and/or coating a material to be coated with a solution or a suspension.

2. Description of Prior Art

Tablet presses and tablet coaters for compressing and coating pharmaceuticals and other substrates are traditionally expensive, complex to operate, difficult to clean and include a multiplicity of parts. Traditional tablet presses are fairly inflexible for accommodating a wide variety of tablet configurations. Likewise, traditional coaters typically adapt to a single coating drum resulting in an inability to handle a wide range of processes and batch sizes in a single coater.

A problem associated with conventional tablet press and coating apparatus is that they require complex and single-purposed apparatus that are not very flexible in operation. In particular, smaller batch lab presses and coaters for use in research and development may require use by numerous technicians or departments that each may require different tablets, coatings and/or particulates. As such, cross-contamination may occur when sharing a single coater and/or tablet press.

Another problem associated with conventional coating apparatus for coating a material with a solution is that they require the use of equipment that is not easily cleaned. Still another problem associated with conventional coating apparatus for coating a material with a solution is that they cannot be disassembled quickly without the use of hand tools or other tools. More specifically, existing coaters include coating drums that are difficult, if not impossible, to extract and/or insert. Yet a further problem associated with conventional coating apparatus is that they foul with product build-up and tend to disrupt the coating process, adversely affecting product quality and thereby leading to disqualified or discarded batches.

Finally, existing technology requires users to clean the equipment in place. However, cleaning in place in a lab environment is generally not desirable.

For the foregoing reasons, there has been defined a long felt and unsolved need for a tablet press and/or coating apparatus that is easily installed, comparatively inexpensive to manufacture and maintain and adjustable to accommodate a variety of applications. In contrast to the foregoing, the present invention constitutes a tablet press and/or coating apparatus that seeks to overcome the problem discussed above while at the same time providing a simple relatively easily constructed apparatus and method that is readily adapted to a variety of applications. In addition, the present invention seeks to combine a tablet press with a flexible coating unit to create a standalone unit capable of manufacturing a coated tablet in a single device.

### BRIEF DESCRIPTION OF THE DRAWINGS

In the detailed description that follows, reference will be made to the following figure:

FIG. 1 is a schematic view of a coating/compression unit according to one preferred embodiment of this invention;

FIG. 2 is a schematic view of a coating/compression unit according to one preferred embodiment of this invention;

FIG. 3 is a schematic view of an exchangeable unitized coating module according to one preferred embodiment of this invention; and

FIG. 4 is a schematic view of an exchangeable unitized tablet press module according to one preferred embodiment of this invention.

### DETAILED DESCRIPTION OF PREFERRED EMBODIMENTS

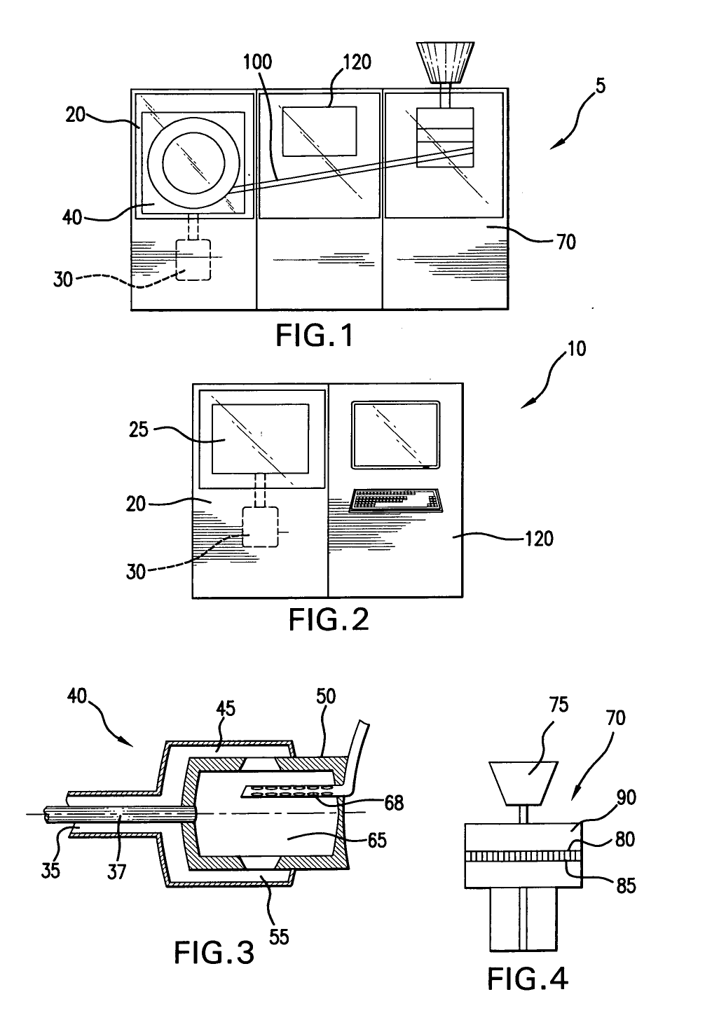

FIGS. 1-4 illustrate various preferred embodiments of the invention. The apparatus described below comprises a modular coater and/or a combination of tablet press and coater that provide a much greater flexibility for the user, particularly at the research level. FIG. 1 shows a combined press and coater apparatus for coating pharmaceutical tablets and similar applications. According to various preferred embodiments of this invention, a preferred apparatus may include: (1) a coating/compression combination unit such as shown in FIG. 1; (2) a combination unit that permits exchange between coating modules and/or compression modules; (3) a unitized, exchangeable coating unit having an exchangeable coating module such as shown in FIG. 3; and/or (4) a platform that includes a tablet press having a removable turret that may be exchanged with a coating module such as shown in FIG. 4.

An electronic measuring and analysis device/interface may be used in connection with the subject invention. One such measuring and analysis device is the PharmaResearch (PhR) manufactured by Korsch. The measuring and analysis device is a console developed to permit data acquisition and analysis of press force and punch displacement data. The device processes data locally and can forward data to a database server on a local network, allowing centralized data storage and analysis.

Suitable tablet presses that may be used in connection with this invention may include a single-punch eccentric press that can be integrated with the measuring and analysis device. Alternatively, a rotary press, such as one accommodating multiple exchangeable turrets, may be integrated with the measuring and analysis device. One example of a single-punch eccentric press is the Korsch XP1. An example of a rotary press having three exchangeable turrets is the Korsch XL100.

According to a preferred embodiment of this invention, such as shown in FIG. 1, coating and compression functions are combined in a single coater/press 5. FIG. 2 shows a schematic of an exchangeable unitized coating unit (XCU) 10. The unitized coating unit 10 may be used in connection with a coating module 40 such as shown in FIG. 3 and/or a tablet press module 70 such as shown in FIG. 4. The coating module 40 is preferably integrated with the electronic measuring and analysis device 120. Traditionally, coaters and tablet presses are available as stand-alone processors which are not connected from a packaging or control point of view. There is generally a low utilization of process equipment at the research level. A benefit of the invention is that operators & scientists only need to be familiar with one system instead of two (human interface, operation, support). Because of the low usage of the equipment, operators and scientists may lose familiarity with the operation of multiple processors so a combined unit will have the added benefit of establishing expertise with a single unit.

As shown in FIG. 2, a coater 10 for coating a material with a solution or a suspension preferably includes a housing 20 and a drive means such as a motor 30. The housing 20 preferably includes a platform 25 for permitting the removal, exchange and connection of one or more modules within the housing 20. For instance, a coating module 40 is preferably removably connected with respect to the housing 20 and the motor 30. The coating module 40 preferably includes an integrated and unitized drum 50, drive shaft 37, inlet plenum 45 and exhaust plenum 55, such as shown schematically in FIG. 3. The coating module 40 may further include an integrated spray bar 68, single nozzle, or similar fluid dispersal means through which a coating solution may be dispersed within the mixing chamber 65.

In operation, the coating module 40 includes a rotatable drum 50 having a central mixing chamber 65 into which tablets or similar substrates are coated with a desired solution. The inlet plenum 45 is in fluid communication with the central mixing chamber 65 and an exterior of the coating module 40 to provide a desired air flow. The exhaust plenum 55 is likewise in fluid communication between the central mixing chamber 65 and the exterior of the coating module 40 to dispense with waste gases and/or fluids.

According to a preferred embodiment of this invention, multiple coating modules 40 having the same or different sizes, configurations and/or characteristics may be exchangeable within the unitized coating unit 10. Preferably, a unitized connector 35 is configured within the coating module 40 to permit a single connection between the housing 20 and the coating module 40 for connecting power, drive, inlet air and/or exhaust.

In addition, or alternatively, a tablet press module 70 such as shown schematically in FIG. 4 may be exchangeable with the coating module 40 within the coating unit 10. The tablet press module 70 preferably includes a feeder 75, a punch 80, a corresponding die plate 85 and an actuation mechanism 90 for engaging the punch 80 with the die plate 85 to form individual tablets.

As such, the tablet press module 70 may be exchangeable within the housing 20 of the unitized coating unit (XCU) 10 shown in FIG. 2 and/or connected within the combination coater/press 5, such as shown in FIG. 1. The combination coater/press 5 shown in FIG. 1 may include removable and exchangeable modules 40, 70, such as described above or may alternatively include a fixed tablet press and a fixed coating unit positioned within a single device 5.

Accordingly, FIG. 1 shows a device 5 for manufacturing and coating pharmaceuticals that includes a housing 20 and a drive 30 wherein a coating module 40 is fixedly or removably positioned within the housing 20 and connected to the drive 30. In addition, a tablet press module 40 is fixedly or removably positioned within the housing 20. Preferably, the tablet press module 70 permits contained selectable access with the coating module 40. Such contained access permits the exchange of completed tablets with the coating module 40 under containment.

According to one preferred embodiment of this invention, the coating unit 5 shown in FIG. 1 may further include a chute 100 connecting an outlet of the tablet press module 70 with an inlet of the coating module 40, the chute 100 permitting direct contained transfer of tablets from the tablet press module to the coating module. The chute 100 may comprise a gravity chute 100 or may include a mechanical assist to transfer tablets from the tablet press module 70 to the coating module 40.

According to a preferred embodiment of this invention, only one processor must be mastered by the users, which is typically the same equipment from one vendor. The apparatus according to this invention permits the user to combine coating with a single-punch press or a rotary press with exchangeable turrets. The electronic measuring and analysis device 120 console equipped with a single-punch eccentric press may further include an integrated coater module 40, such as shown in FIG. 1. Alternatively, the electronic measuring and analysis device 120 console equipped with a rotary press may include an integrated coater module 40.

The subject invention also permits very small scale coating (sub-kilo) under containment. A preferred range of batch sizes for use with the invention may include between approximately 1 and approximately 20 liters. According to one preferred embodiment of this invention, such as shown schematically in FIG. 1, a press such as a tablet press utilizing Korsch's WipCon technology, is integrated with a coater module 40. This adaptation allows coating containment and automated wash of the coater module. Existing small coaters do not coat under containment. Instead, they rely on open transfers and dust can be released to the room during tablet handling, sampling and coating operations. Containment, or closed transfers, greatly reduces the exposure of scientists and operators to tablet dust and the potential for contamination of the room with tablet dust. Contamination and exposure is a potential risk because at the discovery and early research stages of product development the potency of the compounds is not known, as toxicity studies have not been performed yet. Processing under containment as permitted by this invention reduces the risk of dealing with potentially toxic/hazardous active ingredients.

The apparatus according to this invention permits direct tablet transfer from the tablet press to the coater, either in a fixed configuration or a modular configuration. According to one preferred embodiment, a gravity chute 100 or other conveying implementation transfers the compressed cores to the coating drum without operator handling of the tablets. According to prior art systems, the tablets to be coated are manually collected from a tablet press and transferred to a coater (typically located in a different room) where they are manually charged into the coater prior to starting the coating operations. The subject invention potentially eliminates all human involvement and/or interference between and during compression and coating. By processing under containment, the present system reduces the equipment costs as the need for expensive containment transfer devices is reduced. For instance, only a single lab is required to accomplish what would ordinarily require two separate labs.

The subject invention may be manufactured in numerous configurations. The various adaptations and combinations of the measuring and analysis device, single punch tablet press and rotary tablet press allow at least the following five configurations of the device: (1) single punch tablet press only; (2) single punch tablet press and coater module; (3) rotary tablet press only; (4) rotary tablet press and coater module; or (5) rotary tablet press and exchangeable drums/turrets.

The invention further enables the ability to compress and coat different products simultaneously at the discovery and research levels. Specifically, multi-processing and multi-tasking feature of the combined/shared controllers is enabled by the subject invention. Such ability would be enabled in the dual-module configurations only, i.e. a measuring and analysis device with a single punch press or a rotary press with exchangeable turrets utilizing a coater module.

Compression or coating are preferably both available on the same press/platform, such as shown in FIG. 1. According to one embodiment, a removable tablet press module 70 may be included with the apparatus. Conventional units include a compression module (feeders, punch, die plate, actuation and instrumentation) that is integrated to the tablet press. The rotary press may be available as a benchtop execution or a pedestal, floor-mounted execution.

A unitized and exchangeable coating module 40 may also be incorporated with the apparatus of the invention. As such, the coating/mixing chamber 65, drum 50, plenums 45, 55 and spray nozzle positioner may be designed and unitized as a common assembly which can be installed/de-installed as a compact unit. Existing units may include a coating chamber, drum, plenum and nozzle positioner that are designed and assembled as separate subassemblies and are fixed within the unit. The integrated unit of the invention maximizes equipment utilization at the pre-production scales.

The invention may further permit a coating/compression exchangeability, for instance, exchangeable modules for coating and/or compression that may be utilized with a common platform. A floor-mounted exchange cart designed to support and accommodate a removable compression module or a unitized coater module may be used in connection with this feature.

The invention further preferably comprises a single containment connection to the coating unit that handles inlet air, exhaust air and/or drive. This is unlike conventional units that include three or more separate connections for inlet air, exhaust air and drive. Such integration improves usability and reduce cost of the containment make/break connection.

The tablet press according to a preferred embodiment of this invention is equipped to support a coating drum. The dual use apparatus according to this invention permits several shared benefits of features of the individual units. For instance, dust extraction units in the tablet press may be utilized as an extraction fan. In addition, an external and/or integrated blower/heater may be used to supply conditioned process air to the coating unit. Drive turndown may be reduced as a result of the combined unit. Controls may be expanded to monitor process temperatures, dew point, solution flow and coating chamber depression. Similarly, automation may be expanded to control, process temperature, air flow, solution flow, depression and atomizing air. The invention may further be adapted to use the XL100 WipCon features. The housing 20 of the combined unit is preferably modified to allow penetration of the solution lines. In addition, the powder hopper of the tablet press is further modified to load tablets into the exchangeable coating unit. Automation and instrumentation may also be expanded to incorporate thermodynamic analysis models and/or process analytical technologies (PAT) devices.

Existing rotary tablet presses, such as the Korsch XL100, may include exchangeable turrets. Similar mechanisms used in the exchangeable turrets may be adapted to exchange a turret for a coating drum or coating module 40. In this manner, and as shown schematically in FIG. 2, the tablet press becomes a coater and the combination benefits from the components which can be common to compression and coating, namely: housing and packaging; drive; dust extraction; wash-in-place features; containment features; controls; PharmaResearch integration; data acquisition; and/or some instrumentation. Because the turret/drum exchange may be assisted, it may be preferably to implement the operation of a drum with bigger capacity than typical sub-kilo drums (circa 1-25 liters).

The turret exchange mechanism is preferably adapted to easily insert and extract a coating drum or unitized, exchangeable coating unit. The coating chamber, drum, plenums and spray nozzle positioner are designed as a unitized assembly which can be inserted/ extracted in a single movement. Further, the coating chamber and/or turret exchange mechanism are designed to adapt to each other. In this manner, the need to install and de-install several components when exchanging a turret for a drum is eliminated. Further, the need to manually install or de-install the coating components is eliminated.

The invention further permits the ability to insert and extract a drum full of tablets. The drum/turret exchange mechanism is preferably strong enough to insert and extract a drum full of tablets. The full drum can be inserted/extracted under containment by a Bag in/Bag out configuration or other technology similar to the technology implemented for “safe-change” filters. Current coaters are not designed to insert/extract drums under containment. By inserting/extracting drums under containment the subject invention reduces material handling time; and/or eliminates the need to modify the press for tablets loading; reduces or eliminates the need for expensive containment transfer devices to accompany material handling to and from the drum (in-place). Conventional separate units require potent tablets, core and/or coated, to be transferred to/from a containment room when the tablets are handled by operators wearing PPE.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

I claim:

1. A coater for coating a material with a solution or a suspension, the coater comprising:
a housing;
a motor; and
a coating module removably connected with respect to the housing and the motor, the coating module including a drum, an inlet plenum and an exhaust plenum.

2. The coater of claim 1 further comprising:
a second coating module exchangeable with the coating module.

3. The coater of claim 1 further comprising:
a tablet press module exchangeable with the coating module, the tablet press module including a feeder, a punch, a die plate and an actuation mechanism.

4. The coater of claim 1 further comprising:
a tablet press module connected within the housing.

5. The coater of claim 4 further comprising:
a chute connecting an outlet of the tablet press module with an inlet of the coating module, the chute permitting direct contained transfer of tablets from the tablet press module to the coating module.

6. The coater of claim 1 wherein the coating module further comprises:
an integrated spray bar.

7. The coater of claim 1 further comprising:
a unitized connection between the housing and the coating module for connecting power, inlet air and exhaust.

8. A device for manufacturing and coating pharmaceuticals comprising:
a housing including a drive;
a coating module positioned within the housing and connected to the drive; and
a tablet press module positioned within the housing, the tablet press in contained selectable access with the coating module.

9. The device of claim 8 wherein the coating module comprises:
a rotatable drum having a central mixing chamber;
an inlet plenum in fluid communication between the central mixing chamber and an exterior of the coating module; and
an exhaust plenum in fluid communication between the central mixing chamber and the exterior of the coating module.

10. The device of claim 8 wherein the tablet press module comprises:
a feeder;
a punch and a corresponding die plate; and
an actuating mechanism for engaging the punch with the die plate.

11. The device of claim 8 further comprising:
a gravity chute extending between the tablet press module and the coating module.

12. A tablet production device comprising:
a housing;
a motor;
a coating module removably connected with respect to the housing and the motor, the coating module including a drum, an inlet plenum and an exhaust plenum; and
a tablet press module exchangeable with the coating module, the tablet press module including a feeder, a punch, a die plate and an actuation mechanism.

13. The tablet production device of claim 12 wherein the actuation mechanism is connected with respect to the motor.

14. The tablet production device of claim 12 wherein the drum further includes a drive shaft connected to the motor.
